(19) United States
(12) Patent Application Publication
(10) Pub. No.: US 2005/0238846 A1
(43) Pub. Date: Oct. 27, 2005

(54) Gas barrier laminate film, method for producing the same and image display device utilizing the film

(75) Inventors: Hiroshi Arakatsu, Minami-ashigara-shi (JP); Seiya Sakurai, Minami-ashigara-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Fuji Photo Film Co., Ltd., Minami-ashigara-shi (JP)

(21) Appl. No.: 11/076,228

(22) Filed: Mar. 10, 2005

(30) Foreign Application Priority Data
Mar. 10, 2004 (JP) 2004-067077

(51) Int. Cl. B32B 5/16; B05D 5/00

(52) U.S. Cl. 428/141; 428/219; 428/323; 427/202; 427/261

(57) ABSTRACT

In a gas barrier laminate film comprising a gas barrier layer laminated on at least one surface of a support, the surface of the support on the side opposite to the surface laminated with the gas barrier layer is made to have an Ra value of 1 to 20 nm. A gas barrier laminate film that can prevent cracks generated by displacement of rolled film, slacks and wrinkles during rolling up and transportation in the production process of the film and thus can be produced with a high yield, a method for producing the same and an image display device utilizing the film are provided.

### BACKGROUND OF THE INVENTION

1. Field of the Invention

The present invention relates to a gas barrier laminate film preferably used for a plastic flat panel display, a method for producing the same, and an image display device utilizing the film. In particular, the present invention relates to a gas barrier laminate film that can be used for image display devices of flat panel displays required to have high gas barrier property such as those of electroluminescence (EL) displays, a method for producing the same, and an image display device utilizing the film.

2. Description of the Related Art

As supports of flat panel displays, glass substrates have conventionally been used. However, plastic substrates are being actively developed for the purpose of satisfying the recent requirements for displays including lighter weight, prevention of breakage, curved shape and continuous production utilizing a base material in the form of roll. The problems to be solved concerning use of plastic substrates include improvement of barrier performance for oxygen and moisture, improvement of heat resistance and suppression of thermal expansion, and various proposals have been made by various manufacturers. As for improvement of gas barrier performance, in particular, various techniques have been disclosed concerning a method of alternately laminating an organic layer and inorganic layer to impart an action of repairing and buffering defects generated upon formation of the gas barrier layer while making the most of superior gas barrier property of the inorganic layer.

For example, a method of alternately laminating an inorganic layer comprising a metal oxide containing silicon and an organic layer comprising a hexafunctional compound having acryloyl groups and methacryloyl groups is disclosed in Japanese Patent Laid-open Publication (Kokai) No. 2003-94572 (claims). Further, a method of controlling the lamination order of the organic layer and inorganic layer and thickness of the organic layer in such a gas barrier film is disclosed in Japanese Patent Laid-open Publication No. 2002-264274 (claims). Moreover, a method of using a bifunctional epoxy compound and bifunctional phenol compound for the organic layer and using a silicon oxide of which oxygen ratio is controlled for the inorganic layer is disclosed in Japanese Patent Laid-open Publication No. 2003-48271 (claims).

In a gas barrier layer having such a laminate structure, not only the lattice defect density of the inorganic layer, but also the gas barrier property of the organic layer is very important for the gas barrier performance. That is, because oxygen and water molecules that have passed through defects in the first inorganic layer and invaded into the laminate further pass through the organic layer laminated on the first inorganic layer and reach defects portions of the second inorganic layer, the gas barrier property of the organic layer existing between the first and second inorganic layers becomes as a factor determining the gas barrier property of the whole film (refer to U.S. Pat. No. 6,413,645). From this point of view, the gas barrier performance of the organic layer is a very important factor.

Furthermore, the organic layer has a function of absorbing deformation and displacement of the inorganic layer caused by stress applied to the gas barrier layer and thereby preventing fracture of the inorganic layer due to too much degree of such deformation and displacement. In view of gas barrier property and prevention of too much degree of deformation and displacement of the inorganic layer, a harder film recently comes to be more often used for the organic layer, and the laminate films have become fragile films almost similar to glass substrates. In addition, when a support having the aforementioned gas barrier layer is used in a flat panel display, especially EL display device, the surface of the laminate to be brought into contact with the inside of the display device is required to have superior smoothness.

When such a support showing fragility and having superior smoothness is produced in the form of roll, displacement of rolled film, slacks and wrinkles of film are generated during rolling up and transportation of the film, and they reduce yield and value of the film as a commercial product. In addition, during such production, static electricity is discharged in the gas barrier layer to generate pinholes, dusts are adsorbed on the film due to the static electricity, the barrier layer or conductive layer may be delaminated due to blocking, and cracks are generated due to the displacement of rolled film and wrinkles. These phenomena degrade the barrier performance and conduction performance and thus cause marked degradation of the yield.

### SUMMARY OF THE INVENTION

The present invention was accomplished to solve the aforementioned problems, and an object of the present invention is to provide a gas barrier laminate film that can prevent cracks generated by displacement of rolled film, slacks and wrinkles during the production process of the film and thus can be produced with a high yield as a commercial product and a method for producing such a gas barrier laminate film. Another object of the present invention is to provide an image display device utilizing such a film.

The inventors of the present invention found that generation of the displacement of rolled film, slacks and wrinkles during rolling up and transportation of the film were caused because the film surface and back face are adhered due to slight distortion generated in the film during the rolling up and transportation of the film, and they could no longer be corrected thereafter. The inventors of the present invention also found that static electricity was generated in the adhered film, and the delamination electrification became larger in proportion to the size of the adhered area to cause adhesion of dusts and generation of pinholes due to electric discharge.

Based on these findings, the inventors of the present invention attempted to form unevenness on the outer surface of film relative to an image display device in view of reduction of contact area of the film and elimination of static electricity generation. As a result, they found that such unevenness might generate scratches on the gas barrier layer and cause problems of foreign matter defects, blurring, glare, turbidity of images and so forth due to exfoliation of the applied matting agent depending on shape, size, hardness of the unevenness and due to mismatching of formation cycle of protruding portions of the unevenness.

On the basis of the above findings, the inventors of the present invention conducted various researches concerning shape, size, hardness and cycle of protruding and dented portions of unevenness not causing the aforementioned problems. As a result, they found that the aforementioned problems can be solved by forming particular unevenness on the back face of film, and thus accomplished the present invention.

That is, the object of the present invention can be achieved by the gas barrier laminate film and method for producing the same described below.
(1) A gas barrier laminate film comprising a gas barrier layer laminated on at least one surface of a support, wherein a surface of the support on the side opposite to the surface laminated with the gas barrier layer is a surface having unevenness represented by an Ra value (arithmetic average roughness) of 1 to 20 nm.
(2) The gas barrier laminate film according to (1), wherein the gas barrier layer consists of at least three layers of alternately laminated organic layer and inorganic layer.
(3) The gas barrier laminate film according to (1) or (2), which has 50 to 150 mg/m² of a matting agent having an average particle size less than 1 μm as an equivalent spherical diameter, and/or 10 to 25 mg/m² of a matting agent having an average particle size of 1 to 3 μm as an equivalent spherical diameter on the surface of the support on the side opposite to the surface laminated with the gas barrier layer.
(4) The gas barrier laminate film according to (3), wherein the matting agents have a microhardness of 100 to 250 N/mm².
(5) The gas barrier laminate film according to (1) or (2), wherein the surface of the support on the side opposite to the surface laminated with the gas barrier layer is a surface having unevenness formed by at least one kind of treatment selected from the group consisting of corona discharge treatment, electron beam irradiation and flame treatment.
(6) The gas barrier laminate film according to (1) or (2), wherein the surface of the support on the side opposite to the surface laminated with the gas barrier layer is a surface having unevenness formed by pressing an embossing roller having an Ra value of 10 nm to 1 μm and an RSm value (average interval between protruding portions and dented portions) of 20 μm or less.
(7) The gas barrier laminate film according to any one of (1) to (6), wherein the surface of the support on the side opposite to the surface laminated with the gas barrier layer has a surface resistance of 1 to 1×10¹⁰ Ω/□.
(8) The gas barrier laminate film according to any one of (1) to (7), wherein the support is a heat resistant support comprising a polymer having a glass transition temperature of 200° C. or higher.
(9) The gas barrier laminate film according to any one of (1) to (8), wherein the support is a film comprising a polymer having a spiro structure represented by the following formula (1) or a polymer having a cardo structure represented by the following formula (2): 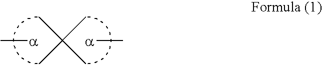
   wherein, in the formula (1), the rings a represent a monocyclic or polycyclic ring, and two of the rings are bound via a spiro bond, 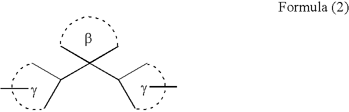
   wherein, in the formula (2), the ring β and the rings γ independently represent a monocyclic or polycyclic ring, and two of the rings γ may be identical or different and are bonded to one quaternary carbon atom in the ring β.
(10) A method for producing a gas barrier laminate film comprising a gas barrier layer laminated on at least one surface of a heat resistant support, wherein before, during or after lamination of the gas barrier layer on the support, the surface of the support on the side opposite to the surface laminated with the gas barrier layer is subjected to at least one kind of treatment selected from the group consisting of corona discharge treatment, electron beam irradiation and flame treatment to form unevenness represented by an Ra value of 1 to 20 nm on the treated surface.
(11) A method for producing a gas barrier laminate film comprising a gas barrier layer laminated on at least one surface of a heat resistant support, wherein before, during or after lamination of the gas barrier layer on the support, the surface of the support on the side opposite to the surface laminated with the gas barrier layer is pressed with an embossing roller having an Ra value of 10 nm to 1 μm and an RSm value of 20 μm or less to form unevenness represented by an Ra value of 1 to 20 nm on the treated surface.

The other object of the present invention is achieved by an image display device utilizing the gas barrier laminate film according to any one of (1) to (9).

In the gas barrier laminate film of the present invention, unevenness represented by an Ra value of 1 to 20 nm is formed on the surface of the support on the side opposite to the surface laminated with the gas barrier layer. By this characteristic, the present invention can provide a gas barrier laminate film that can effectively prevent adhesion and delamination of the back face of the support and the gas barrier layer during rolling up and transportation, does not damage the gas barrier layer, exhibits little degradation of gas barrier performance and conduction performance due to handling of the support and is suitable for image display devices for flat panel displays and so forth.

Moreover, an image display device having superior gas barrier performance can be provided, if it is the image display device of the present invention, and it can be suitably used for flat panel displays and so forth.

### BEST MODE FOR CARRYING OUT THE INVENTION

Hereafter, the gas barrier laminate film of the present invention and image display device utilizing the film of the present invention will be explained in detail.

The ranges expressed with “to” in the present specification mean ranges including the numerical values indicated before and after “to” as a lower limit value and upper limit value.

[Gas Barrier Laminate Film]

The gas barrier laminate film of the present invention is a gas barrier laminate film in which prevention of degradation of gas barrier performance during the production process is enabled by controlling characteristics of the film back face (henceforth referred to as the “film of the present invention”).

In the present specification, the “surface of the support on the side opposite to the surface laminated with the gas barrier layer” means the surface of the support on the side opposite to the surface of the support laminated or to be laminated with the gas barrier layer. When the gas barrier layers are laminated on the both surfaces of the film, the “surface on the opposite side” means the outermost surface on the side opposite to the surface of the support on which display layers such as luminescence layer and liquid crystal layer are formed in the fabrication of flat panel displays, i.e., the outermost surface on the side opposite to the side of the support of which surface is laminated with the gas barrier layer to shield oxygen, moisture etc.

In the present specification, the surface of the support on the side opposite to the surface on which the gas barrier layer is laminated is referred to as the “back face”, and the surface on the side opposite to the back face is referred to as “surface” hereinafter for convenience.

In the film of the present invention, the back face of the film has unevenness represented by an Ra value of 1 to 20 nm. The Ra value (arithmetic average roughness) of the back face of the film of the present invention is 1 to 20 nm, preferably 2 to 8 nm, more preferably 3 to 7 nm. If the Ra value is 1 nm or more, sufficient lubricity and anti-blocking property can be secured. On the other hand, if the Ra value is 20 nm or less, the film surface is not damaged by the formed protruding portions, neither cracks nor pinholes are generated in the gas barrier layer on the film surface side, and the protruding portions are not broken, exfoliated and transferred to the film surface to generate foreign matter defects. Moreover, if the size of the protruding portions is 20 nm or less, reduction of resolution is not caused by the presence of the protruding portions, and the surface dose not whitely glare to make it difficult to see images when external light irradiates the film.

The Ra value on the back face of the film can be measured by using “Micromap” produced by RYOKA SYSTEM Inc.

In the present invention, as the method for forming a surface having unevenness represented by an Ra value of 1 to 20 nm as the film back face, various formation methods such as chemical etching, physical etching, embossing and coating of matting agents (so-called delustering agents, comprising organic or inorganic microparticles of a predetermined size) can be used. Further, a method of using a casting drum for the production of the film (support) of which surface is intentionally roughened to form unevenness may also be used. In view of cost reduction and prevention of exfoliation of the matting agent, in particular, a method of forming unevenness in the support itself is preferably employed, so long as the support does not consist of a resin of high hardness. Furthermore, when a functional layer such as transparent conductive layer and anti-curling layer is provided on the film back face, unevenness can be formed on the film back face by, for example, increasing vapor deposition rate, decreasing the distance from the vapor deposition source in the vapor deposition method, increasing the drying rate or adding a matting agent in the application method.

When the chemical etching method is used, unevenness can be formed on the film back face by dissolution with a solvent, hydrolysis with an acid or alkali, oxidization with ozone or the like. Further, when the physical etching method is used, unevenness can be formed on the film back face by polishing with an abrasive, etching with ion beam, plasma, corona discharge treatment or the like, flame treatment or the like. It is preferable to use at least one kind of treatment selected from the group consisting of corona discharge treatment, ion beam treatment and flame treatment. These methods for forming unevenness may be independently performed, or two or more kinds of the methods may be used in combination.

When unevenness is formed on the film back face, unevenness is preferably formed at least during a period after the gas barrier layer is formed on the film surface and before the film is rolled up for the first time or the lamination of the gas barrier layer is completed. Unevenness is more preferably formed on the back face of the support before the lamination of the gas barrier layer on the support is completed.

When unevenness is formed on the back face of the support by applying a matting agent, type of the matting agent used is not particularly limited so long as colorless particles are used, and any organic and inorganic microparticles can be used. Examples of the organic microparticles include, for example, microparticles of common thermoplastic resins such as polystyrenes and polyethylene terephthalates, microparticles of heat resistant thermoplastic resins, which can be preferably used in the support of the present invention, and so forth. As the organic microparticles, microparticles of thermosetting resins such as benzoguanamine resins, urethane resins and phenol resins can also be used. Examples of the inorganic microparticles include, for example, inorganic particles of silica, titanium oxide, talc, calcium carbonate and so forth can be used.

Among these particles, microparticles produced by a fusion method can be preferably used, because such particles do not have sharply protruding portions, and therefore the particles cause little irregular reflection of light and scarcely damage the film surface.

The matting agent used preferably has heat resistance, and for example, a matting agent of a thermoplastic resin or thermosetting resin having Tg of 200° C. or higher or an inorganic material having a melting point of 200° C. or higher can be used.

If the size of the matting agent used is too large, irregular reflection of light becomes significant, and images becomes less clear. In addition, stress may be concentrated on the matting agent portions, and the barrier layer may be broken. On the other hand, if the particle size is too small, the effect obtained by addition of the matting agent may be reduced. From these points of view, the average particle size of the matting agent is preferably in the range of 0.05 to 3 μm in terms of equivalent spherical diameter, more preferably 0.1 to 1 μm in terms of equivalent spherical diameter.

The term “equivalent spherical diameter” used herein means a diameter of sphere having the same volume as the matting agent of the average particle size.

Shape of the matting agent used is preferably a particle shape not having any sharply protruding portions, and those having a spherical shape or rugby ball shape are preferably used.

Although the application amount of the matting agent on the support may vary depending on the particle size, it is 1 to 50 mg/m², preferably 3 to 40 mg/m², more preferably 5 to 30 mg/m², still more preferably 10 to 25 mg/m², most preferably 10 to 15 mg/m², for matting agents having an average particle size of 1 to 3 μm in terms of an equivalent spherical diameter. Further, for matting agents having an average particle size less than 1 μm in terms of an equivalent spherical diameter, it is preferably 50 to 150 mg/m², more preferably 75 to 125 mg/m², still more preferably 85 to 100 mg/m². If a matting agent having an average particle size of 1 to 3 μm in terms of an equivalent spherical diameter is applied in an amount of 1 to 50 mg/m², adhesion of the support can be favorably prevented while maintaining high transparency. If a matting agent having an average particle size less than 1 μm in terms of an equivalent spherical diameter is applied in an amount of 50 to 150 mg/m², adhesion of the support can also be favorably prevented while maintaining high transparency.

Refractive index of the matting agent used is preferably similar to that of the surrounding binder, and the difference of refractive indexes of the matting agent and the binder is desirably 0.1 or less, more preferably 0.05 or less, most preferably 0.005 or less. From this viewpoint, the matting agent used preferably comprises the same material as that of the binder. In addition, the binder preferably has a heat resistant temperature of 200° C. or higher.

If hardness of the matting agent is too low, the matting agent may be easily deformed by pressure, thus the adhesion area between the film surface and back face may increase, and adhesion strength may increase. If hardness of the matting agent is too high, the matting agent may damage the film surface. From these points of view, the hardness of the matting agent is desirably lower than the hardness of the film surface, and it is preferably 100 to 250 N/mm² , more preferably 120 to 200 N/mm², still more preferably 130 to 170 N/mm².

Hardness of the matting agent can be obtained by using a surface microhardness meter (Fischer Scope H100 VP-HCU produced by Fischer Instruments) for a matting agent of the same material having a large size or a plate of the same material. Specifically, the hardness can be obtained by applying a application solution dispersing the matting agent together with the binder on a glass substrate as thin as possible, pushing a diamond pyramid indenter (tip face angle: 136°) into the applied layer with such an appropriate test load that the pushing depth should become 0.5 μm or more and less than 10% of the particle size of the matting agent, measuring the pushing depth and calculating the hardness from change of positions under the load and without the load. If the matting agent of a large particle size cannot be obtained, the hardness may also be measured by using AFM.

When the unevenness is formed by subjecting the support to an embossing treatment, the embossing treatment can be performed by putting the support between an embossing roller and a backup roller. As for the time of the embossing treatment, it may be performed at the time of the production of the support, or may be performed apart from the production of the support. Although the embossing pattern may be a regular pattern or random pattern, it is preferably a random pattern because such a pattern is unlikely to generate moire and conspicuous unevenness.

If unevenness cycle (average interval between protruding portions and dented portions, RSm value) of embossing plate used for the embossing treatment is too large, blurring and unsharpness of images may be generated to degrade precision. On the other hand, if the unevenness cycle is too small, the surface may become cloudy. From these points of view, the unevenness cycle (RSm value) of the embossing plate is preferably 5 to 50 μm, more preferably 8 to 30 μm, most preferably 10 to 20 μm. Further, the arithmetic average roughness (Ra value) of unevenness of the embossing plate is preferably 10 nm to 1 μm, more preferably 20 to 500 nm, most preferably 50 to 300 nm.

As the method for forming unevenness of the embossing plate, conventional methods such as electrical discharge processing, laser processing and sandblasting can be used. In view of randomicity of unevenness, cycle, size and uniformity of unevenness, electrical discharge processing is preferably used.

The back face of the film of the present invention preferably has a surface resistance of 1 to 1×10¹⁰ Ω/□, more preferably 1 to 1×10⁸ Ω/□, most preferably 1 to 1×10⁶ Ω/□, in an environment of 25° C. and 50% RH. If the surface resistance of the film back face is 1 to 1×10¹⁰ Ω/□ or lower, scratches are not generated on the gas barrier layer of the film, and foreign matter defects are not generated due to exfoliation of the matting agent.

The surface resistance of the back surface of the film can be measured by using, for example, Model 8009, RESISTIVITY TEST FIXTURE produced by KEITHLEY and Model 6517A produced by KEITHLEY, after the sample is conditioned for moisture content at 25° C. and 50% RH for 3 hours or longer.

Hereafter, the members constituting the gas barrier laminate film of the present invention will be explained in detail.

<Support>

As the support material used in the film of the present invention, a thermoplastic resin or thermosetting resin may be used so long as a resin having heat resistance is chosen. Preferred support materials are resins having a glass transition temperature (Tg) of 200° C. or higher, preferably 250 to 600° C., more preferably 300 to 550° C. A resin for which glass transition temperature is not substantially observed (for example, for a measurement range of 400° C. or lower) can also be preferably used in the present invention.

Among the aforementioned resins, resins having a high glass transition temperature or substantially colorless and transparent resins are preferred. Specifically, polyimide resins (e.g., Kapton (trade name, produced by DuPont, 400° C. or higher)), Upilex-R (trade name, produced by Ube Industries, 285° C.), Upilex-S (trade name, produced by Ube Industries, 400° C. or higher)), fluorinated polyimide resins (e.g., Flupi-01 (trade name, produced by NTT, 335° C.)), polyarylate resins (e.g., condensates of bisphenol A, isophthalic acid and terephthalic acid, 210° C.), polyetherimides (e.g., Ultem (trade name, produced by GE, 215° C.)), polyethersulphones (PES, 220° C.), fluorene ring-modified polycarbonate resins (BCF-PC, the compound of Japanese Patent Laid-open Publication No. 2000-227603, Example 4, 225° C.), aliphatic ring-modified polycarbonate resins (IP-PC, the compound of Japanese Patent Laid-open Publication No. 2000-227603, Example 5, 205° C.), acryloyl resins (the compound of Japanese Patent Laid-open Publication No. 2002-80616, Example 1, 300° C. or higher) and so forth can be preferably used (the temperatures indicated in the parentheses represent Tg).

Particularly preferred examples of the resin having Tg of 200° C. or higher used for the support include polymers having a spiro structure represented by the formula (1) and polymers having a cardo structure represented by the formula (2). These polymers are compounds showing high heat resistance, high elastic modulus and high tension fracture stress and suitable as substrate materials for displays such as organic EL devices and so forth, for which various heating operations are required in the production processes and performance of being unlikely to fracture even when they are bent is required.

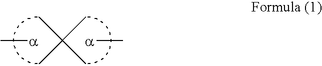

In the formula (1), the rings a represent a monocyclic or polycyclic ring, and two of the rings are bound via a spiro bond.

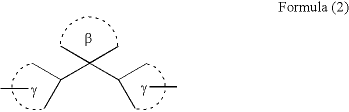

In the formula (2), the ring β and the rings γ independently represent a monocyclic or polycyclic ring, and two of the rings γ may be identical or different and are bonded to one quaternary carbon atom in the ring β.

Preferred examples of the polymers having a spiro structure represented by the formula (1) include polymers containing a spirobiindane structure represented by the following formula (3) in repeating units, polymers containing a spirobichroman structure represented by the following formula (4) in repeating units, and polymers containing a spirobibenzofuran structure represented by the following formula (5) in repeating units.

Preferred examples of the polymers having a cardo structure represented by the formula (2) include polymers containing a fluorene structure represented by the following formula (6) in repeating units.

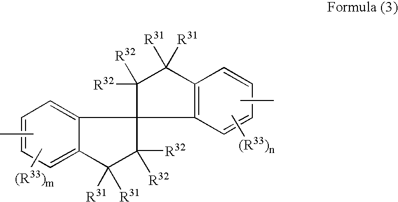

In the formula (3), R³¹ and R³² each independently represent hydrogen atom or a substituent, and R³³ represents a substituent. Groups of each type may bond to each other to form a ring. m and n represent an integer of 0 to 3. Preferred examples of the substituent include a halogen atom, an alkyl group and an aryl group. More preferred examples of R³¹ and R³² are hydrogen atom, methyl group and phenyl group, and more preferred examples of R³³ are chlorine atom, bromine atom, methyl group, isopropyl group, tert-butyl group and phenyl group.

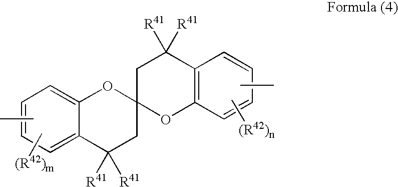

In the formula (4), R⁴¹ represents hydrogen atom or a substituent, and R⁴² represents a substituent. Groups of each type may bond to each other to form a ring. m and n represent an integer of 0 to 3. Preferred examples of the substituent include a halogen atom, an alkyl group and an aryl group. More preferred examples of R⁴¹ are hydrogen atom, methyl group and phenyl group, and more preferred examples of R⁴² are chlorine atom, bromine atom, methyl group, isopropyl group, tert-butyl group and phenyl group.

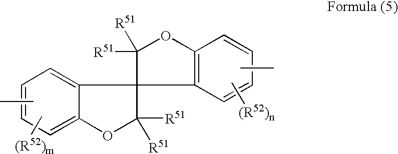

In the formula (5), R⁵¹ represents hydrogen atom or a substituent, and R⁵² represents a substituent. Groups of each type may bond to each other to form a ring. m and n represent an integer of 0 to 3. Preferred examples of the substituent include a halogen atom, an alkyl group and an aryl group. More preferred examples of R⁵¹ are hydrogen atom, methyl group and phenyl group, and more preferred examples of R⁵² are chlorine atom, bromine atom, methyl group, isopropyl group, tert-butyl group and phenyl group.

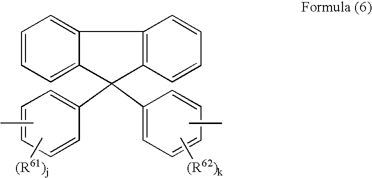

In the formula (6), R⁶¹ represents hydrogen atom or a substituent, and R⁶² represents a substituent. Groups of each type may bond to each other to form a ring. j and k represent an integer of 0 to 4. Preferred examples of the substituent include a halogen atom, an alkyl group and an aryl group. More preferred examples of R⁶¹ and R⁶² are chlorine atom, bromine atom, methyl group, isopropyl group, tert-butyl group and phenyl group.

The polymers containing a structure represented by any one of the formulas (3) to (6) in repeating units may be polymers formed with various bonding schemes such as polycarbonates, polyesters, polyamides, polyimides and polyurethanes. However, the polymers are preferably polycarbonates, polyesters or polyurethane derived from a bisphenol compound having a structure represented by any one of the formulas (3) to (6) in view of optical transparency.

Preferred specific examples of the polymers having a structure represented by the formula (1) or formula (2) are shown below. However, the present invention is not limited to these.

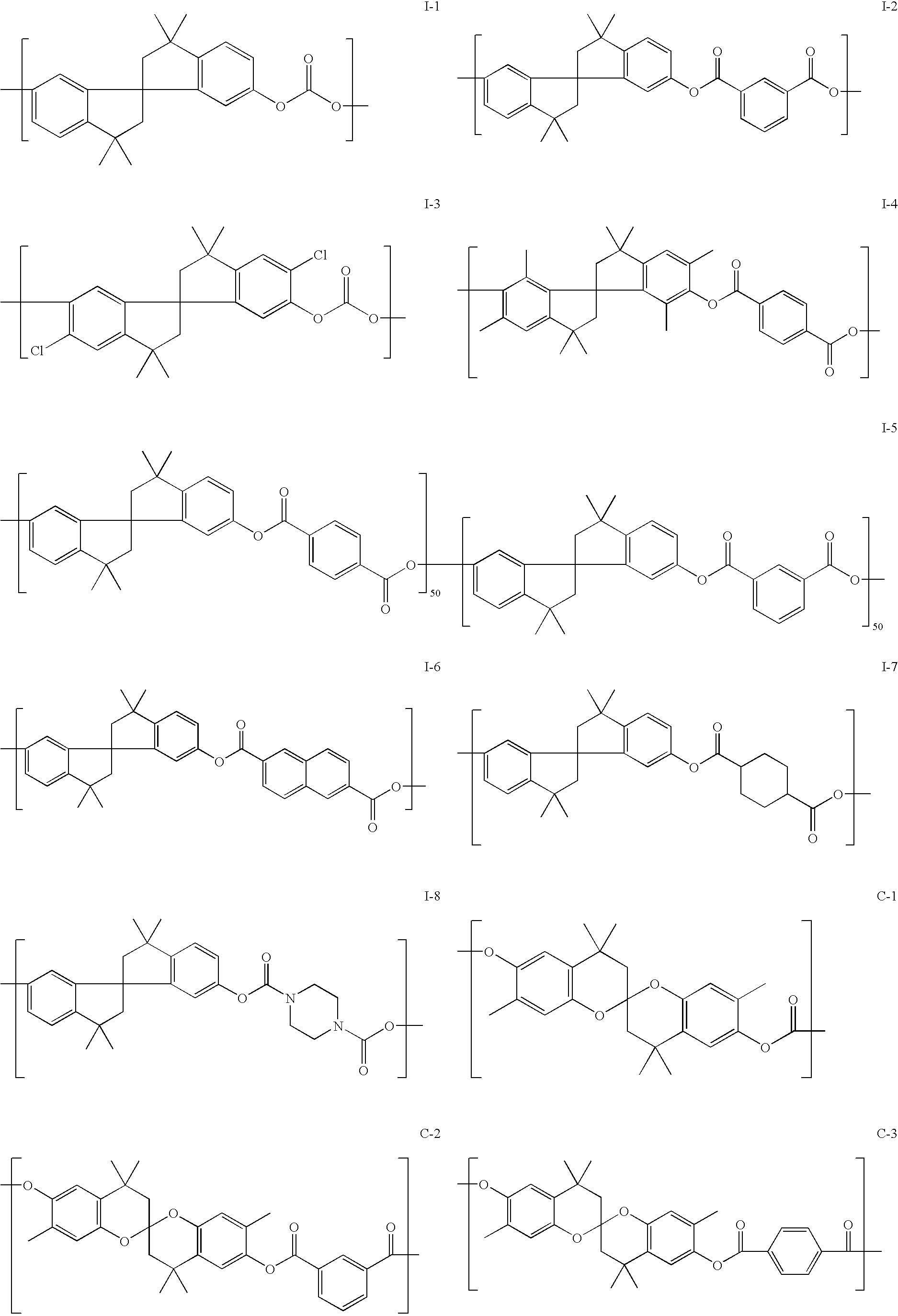

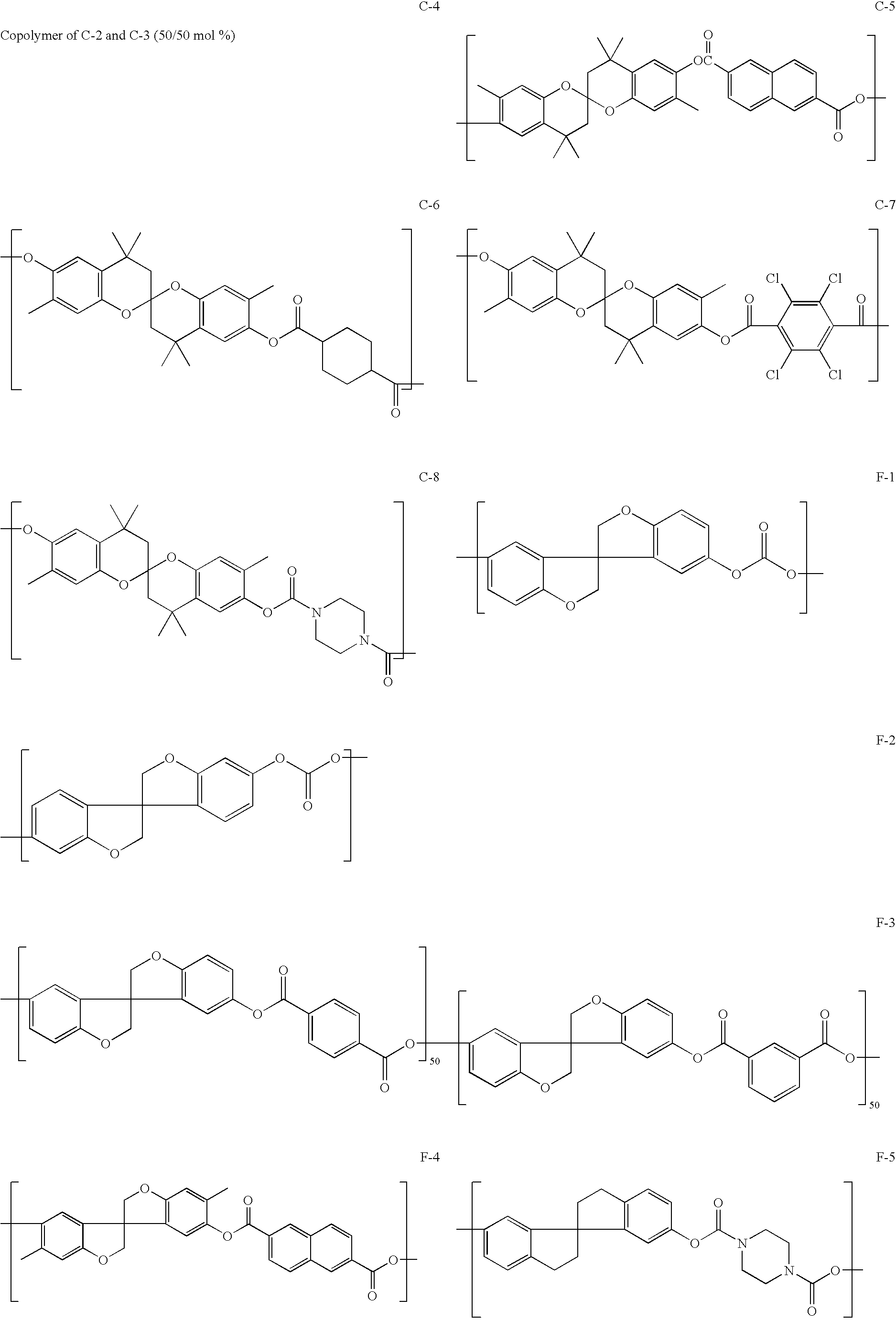

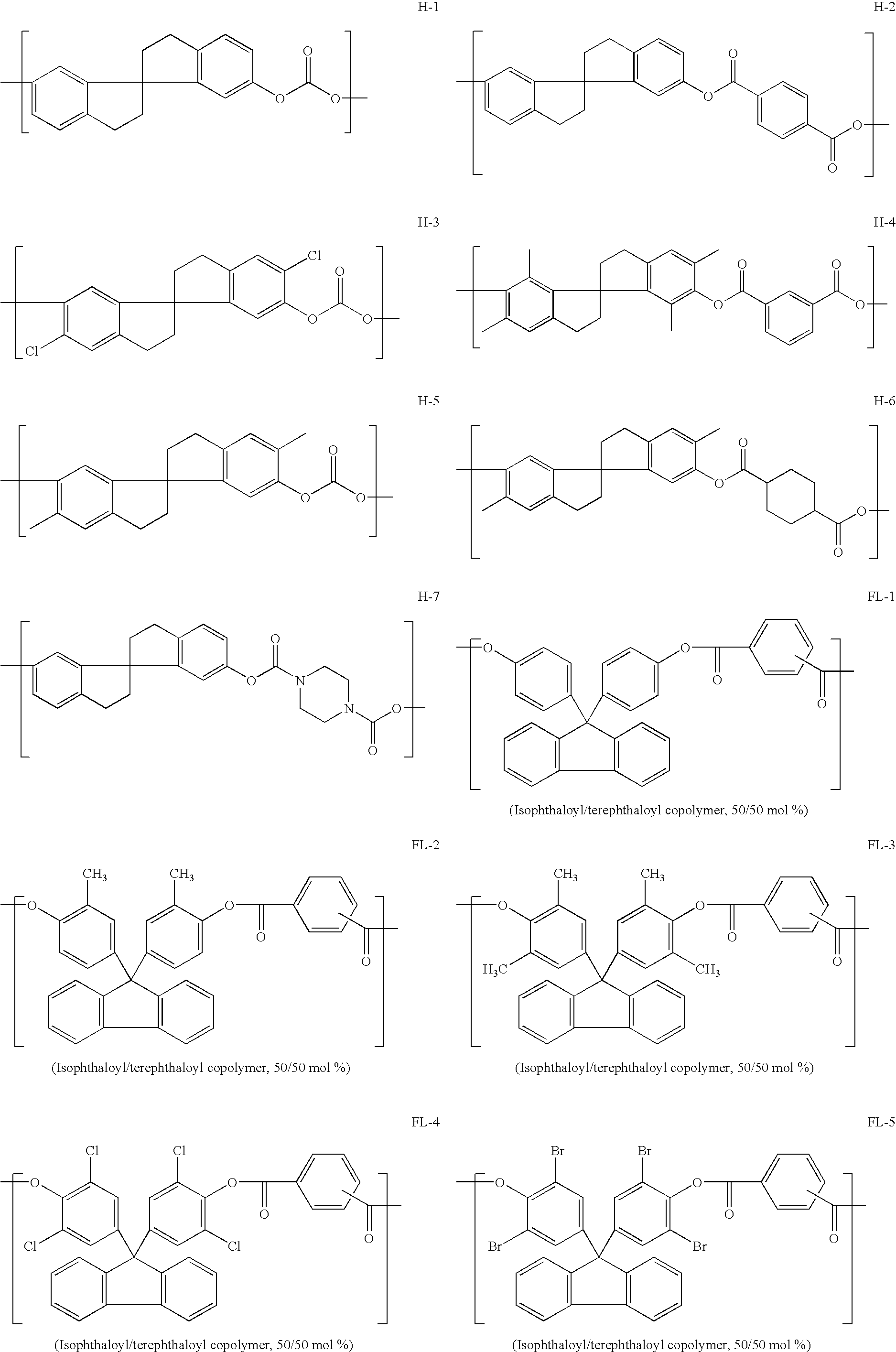

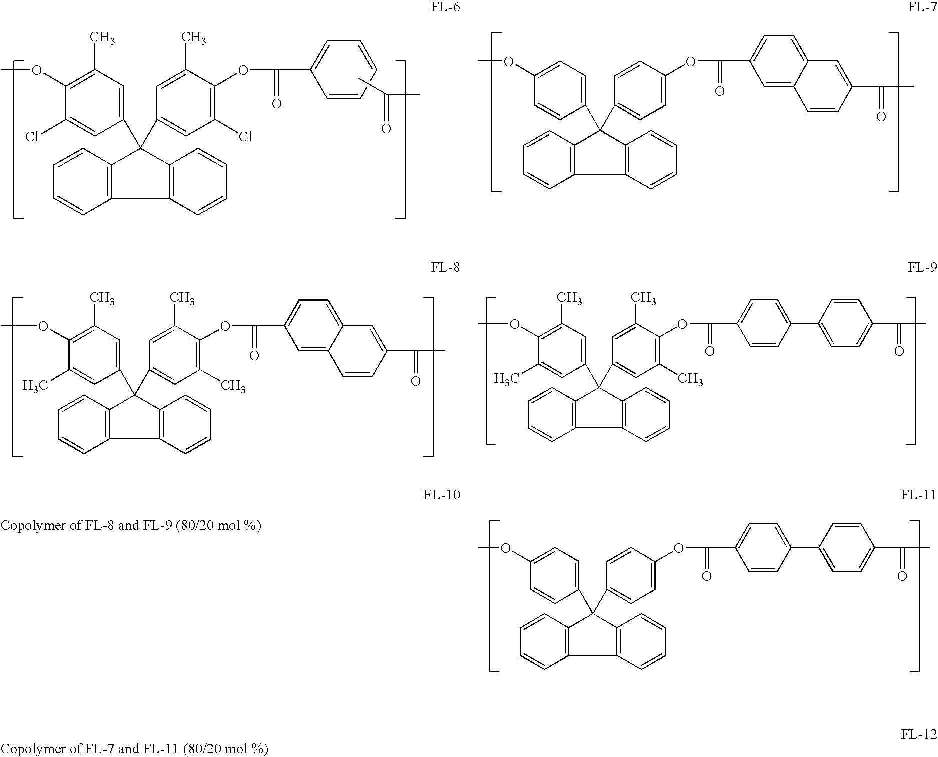

The polymers having a structure represented by the formula (1) or formula (2) used for the support of the present invention may be used independently, and may be used as a mixture of two or more kinds of them. Moreover, they may be homopolymers or copolymers comprising a combination of two or more kinds of the structures. When a copolymer is used, a known repeating unit not containing a structure represented by the formula (1) or (2) in the repeating unit may be copolymerized within such a degree that the advantages of the present invention should not be degraded. Copolymers more often have improved solubility and transparency compared with homopolymers, and such copolymers can be preferably used.

The polymers having a structure represented by the formula (1) or formula (2) used for the support of the present invention preferably has a molecular weight of 10,000 to 500,000, more preferably 20,000 to 300,000, particularly preferably 30,000 to 200,000, in terms of weight average molecular weight. If the molecular weight is too small, fabrication of the film may become difficult, and mechanical characteristics may be degraded. On the other hand, if the molecular weight is too large, it may become difficult to control the molecular weight during the synthesis, and handling may become difficult due to unduly high viscosity of solution. The molecular weight may also be determined on the basis of corresponding viscosity.

In the present invention, as the resin used for the support, curable resins (crosslinkable resins), which have superior solvent resistance and heat resistance, may be also preferably used in addition to thermoplastic resins so long as a resin having Tg of 200° C. or higher is chosen. As for the types of the curable resins, both of thermosetting resins and radiation-curable resins can be used, and those of known types can be used without particular limitations. Examples of the thermosetting resins include phenol resins, urea resins, melamine resins, unsaturated polyester resins, epoxy resins, silicone resins, diallyl phthalate resins, furan resins, bismaleimide resins, cyanate resins and so forth.

As for the method for crosslinking the aforementioned curable resins, any reactions that form a covalent bond may be used without any particular limitation, and systems in which the reactions proceed at room temperature, such as those utilizing a polyhydric alcohol compound and a polyisocyanate compound to form urethane bonds, can also be used without any particular limitation. However, such systems often have a problem concerning the pot life before the film formation, and therefore such systems are usually used as two-pack systems, in which, for example, a polyisocyanate compound is added immediately before the film formation. On the other hand, if a one-pack system is used, it is effective to protect functional groups to be involved in the crosslinking reaction, and such systems are marketed as blocked type curing agents.

Known as the marketed blocked type curing agents are B-882N produced by Mitsui Takeda Chemicals, Inc., Coronate 2513 produced by NIPPON POLYURETHANE INDUSTRY CO., LTD. (these are blocked polyisocyanates), Cymel 303 produced by Mitsui-Cytec Ltd. (methylated melamine resin) and so forth. Moreover, blocked carboxylic acids, which are protected polycarboxylic acids usable as curing agents of epoxy resins, such as B-1 mentioned below, are also known.

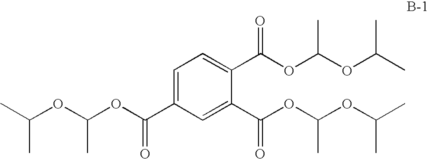

The radiation curable resins are roughly classified into radically curable resins and cationic curable resins. As a curable component of the radically curable resins, a compound having two or more radically polymerizable groups in the molecule is used, and as typical examples, compounds having 2 to 6 acrylic acid ester groups in the molecule called polyfunctional acrylate monomers, and compounds having two or more acrylic acid ester groups in the molecule called urethane acrylates, polyester acrylates and epoxy acrylates are used.

Typical examples of the method for curing radically curable resins include a method of irradiating an electron ray and a method of irradiating an ultraviolet ray. In the method of irradiating an ultraviolet ray, a polymerization initiator that generates a radical by ultraviolet irradiation is usually added. If a polymerization initiator that generates a radical by heating is added, the resins can also be used as thermosetting resins.

As a curable component of the cationic curable resins, a compound having two or more cationic polymerizable groups in the molecule is used. Typical examples of the curing method include a method of adding a photoacid generator that generates an acid by irradiation of an ultraviolet ray and irradiating an ultraviolet ray to attain curing. Examples of the cationic polymerizable compound include compounds containing a ring opening-polymerizable group such as epoxy group and compounds containing a vinyl ether group.

For the support used in the present invention, a mixture of two or more kinds of resins selected from each type of the aforementioned thermosetting resins and radiation curable resins may be used, and a thermosetting resin and a radiation curable resin may be used together. Further, a mixture of a curable resin (crosslinkable resin) and a resin not having a crosslinkable group may also be used.

The aforementioned curable resin (crosslinkable resin) is preferably mixed in the support, because solvent resistance, heat resistance, optical characteristics and toughness of the support can be thereby obtained. Moreover, it is also possible to introduce crosslinkable groups into a resin used for the support, and such a resin may have the crosslinkable group at any of end of polymer main chain, positions in polymer side chain and polymer main chain. When such a resin is used, the support may be prepared without using the aforementioned commonly used crosslinkable resin together.

When the film of the present invention is used for liquid crystal displays and so forth, it is preferable to use an amorphous polymer as the resin used in order to attain optical uniformity. Furthermore, for the purpose of controlling retardation (Re) and wavelength dispersion thereof, polymers having positive and negative intrinsic birefringences may be combined, or a resin showing a larger (or smaller) wavelength dispersion may be combined.

In the present invention, a laminate of different resins or the like may be preferably used as the support in order to control retardation (Re) or improve gas permeability and mechanical characteristics. No particular limitation is imposed on preferred combinations of different resins, and any combinations of the aforementioned resins can be used.

The support used in the present invention may be stretched. Stretching provides advantages of improvement of mechanical strengths of the film such as anti-folding strength, and thus provides improvement of handling property of the support. In particular, a support having an orientation release stress (ASTM D1504, henceforth abbreviated as “ORS”) of 0.3 to 3 GPa along the stretching direction is preferred, because mechanical strength of such a support is improved. ORS is internal stress present in a stretched film or sheet generated by stretching.

Known methods can be used as the stretching method, and the stretching can be performed by, for example, the monoaxial stretching method by roller, monoaxial stretching method by tenter, simultaneous biaxial stretching method, sequential biaxial stretching method or inflation method at a temperature of from a temperature higher than Tg of the resin by 10° C. to a temperature higher than Tg by 50° C. The stretching ratio is preferably 1.1 to 3.5 times.

Although the thickness of the support used in the present invention is not particularly limited, it is preferably 30 to 700 μm, more preferably 40 to 400 μm, still more preferably 50 to 200 μm. The haze (parallel light transmission) of the support is preferably 3% or less, more preferably 2% or less, still more preferably 1% or less. Further, the total light transmission of the support is preferably 70% or more, more preferably 80% or more, still more preferably 90% or more.

The support used in the present invention may contain resin property modifiers such as plasticizers, dyes and pigments, antistatic agents, ultraviolet absorbers, antioxidants, inorganic microparticles, release accelerators, leveling agents, inorganic layered silicate compounds and lubricants as required in such a degree that the advantages of the present invention are not degraded.

<Gas Barrier Layer>

Hereafter, the members constituting the gas barrier layer comprising laminated organic layer and inorganic layer preferably used for the gas barrier layer of the present invention will be explained.

(Inorganic Layer)

In the present invention, type and formation method of the inorganic layer are not particularly limited, and known inorganic layers and film formation methods therefor may be used. Although the inorganic layer may be formed by any method so long as a method that can form an objective thin film is chosen, sputtering method, vacuum deposition method, ion plating method, plasma CVD method and so forth are suitable, and the film formation can be attained by, for example, the methods described in Japanese Patent No. 3400324, Japanese Patent Laid-open Publication Nos. 2002-322561 and 2002-361774.

The material of the inorganic layer is not particularly limited, and for example, oxides, nitrides, oxynitrides etc. containing one or more kinds of elements selected from Si, Al, In, Sn, Zn, Ti, Cu, Ce, Ta and so forth can be used. The thickness of the inorganic layer is not also particularly limited. However, when it is too large, cracks may be generated by bending stress, and when it is too small, the film may be distributed in an island pattern. In the both cases, gas barrier property tends to be degraded. From this viewpoint, the thickness of each inorganic layer is preferably in the range of 5 to 1000 nm, more preferably 10 to 1000 nm, most preferably 10 to 200 nm.

Further, when two or more inorganic layers are formed, they may have the same composition or different compositions. In order to obtain both of gas barrier property and high transparency, it is preferable to use silicon oxide or silicon oxynitride for the inorganic layer. Silicon oxide is represented as SiOₓ. For example, when SiOₓ is used for the inorganic substance layer, x is desirably more than 1.6 and less then 1.9 (1.6<x<1.9) in order to obtain both of favorable gas barrier property and high light transmission. Silicon oxynitride is represented as SiOₓN_{y}. As for the ratio of x and y, when improvement of adhesion property is emphasized, an oxygen rich film is preferred, and thus it is preferred that x is more than 1 and less than 2, and y is more than 0 and less than 1 (1<x<2, 0<y<1). When improvement of gas barrier property is emphasized, a nitrogen rich film is preferred, and thus it is preferred that x is more than 0 and less than 0.8, and y is more than 0.8 and less than 1.3 (0<x<0.8, 0.8<y<1.3).

(Organic Layer)

In the film of the present invention, the organic layer is adjacently provided to the inorganic layer for the purpose of improving the gas barrier property of the inorganic layer.

The “organic layer” referred to in this specification means a layer having a function of compensating defects of the inorganic layer (defect-compensating layer), and it also includes an inorganic oxide layer and organic/inorganic hybrid layer formed by a sol-gel method. The organic layer referred to in the present specification may contain an ingredient other than organic ingredients, i.e., inorganic substances, inorganic elements, metal elements etc.

In the film of the present invention, the organic layer is desirably formed by curing radically polymerizable monomers having a vinyl group such as acrylate group or methacrylate group or cationic ring-open polymerizable monomers having a cyclic ether group such as epoxy group or oxetanyl group. These monomers may be monofunctional or polyfunctional depending on the use, and a mixture of monomers of different functionalities may also be used.

The organic layer used in the film of the present invention may be formed with an organic/inorganic hybrid material by using hydrolysis and a polycondensation reaction of a metal alkoxide together. As the metal alkoxide, alkoxysilanes and/or metal alkoxides other than alkoxysilanes are used. As the metal alkoxides other than alkoxysilanes, zirconium alkoxides, titanium alkoxides, aluminum alkoxides and so forth are preferred. Moreover, inorganic fillers such as known inorganic microparticles and layered silicates may be mixed in the organic layer as required.

Examples of the method of forming the organic layer include an application method, vacuum film formation method and so forth. Although the vacuum film formation method is not particularly limited, vapor deposition, plasma CVD and so forth are preferred, and the resistance heating vapor deposition method is more preferred, in which film formation rate of organic monomers is easily controlled. Although the method of crosslinking the organic monomers is not limited at all, crosslinking by means of irradiation of active energy ray such as electron ray or ultraviolet ray is preferred for the reasons that equipment therefor is easily disposed in a vacuum chamber, and it rapidly provides a higher molecular weight by crosslinking reactions.

When the organic layer is formed by an application method, conventionally used various application methods such as roller coating, photogravure coating, knife coating, dip coating, curtain flow coating, spray coating and bar coating can be used.

The active energy ray used in the method of crosslinking the organic monomers refers to radiation that can transmit energy with irradiation. Examples of the active energy ray include ultraviolet ray, X-ray, electron ray, infrared ray, microwave or the like, and type and energy thereof can be arbitrarily chosen depending on the use.

The aforementioned cationic ring-opening polymerization of the monomers is initiated, after a composition containing the monomers is coated or vapor-deposited, by contact heating using a heater or the like or irradiation heating using infrared rays, microwaves or the like when a thermal polymerization initiator is used. When a photopolymerization initiator is used, an activity energy ray can be irradiated to initiate the polymerization. For irradiation of a ultraviolet ray, various light sources can be used, and for example, curing can be attained by the illuminating light of a mercury arc lamp, xenon arc lamp, fluorescence lamp, carbon arc lamp, tungsten-halogen radiation lamp, sunlight or the like.

The irradiation intensity of ultraviolet ray is at least 0.01 J/cm². When the curing is attained continuously, it is preferable to set the irradiation rate so that the composition can be cured within 1 to 20 seconds. When the curing is attained with an electron ray, the curing is attained with an electron ray having an energy of 300 eV or less, or it is also possible to attain the curing instantly with irradiation of 1 to 5 Mrad.

In the film of the present invention, although the thickness of the organic layer is not particularly limited, it is preferably in the range of 10 nm to 5000 nm, more preferably 10 nm to 2000 nm, most preferably 10 nm to 500 nm. If the thickness of the organic layer is 10 nm or larger, an organic layer having a uniform thickness can be formed, and thus structural defects of the inorganic layer can be efficiently filled with the organic layer. Therefore, the barrier performance can be improved. Further, if the thickness of the organic layer is 5000 nm or smaller, cracks are not generated in the organic layer by an external force such as bending forth, and thus the problem of degradation of the barrier property can be obviated.

In the film of the present invention, the gas barrier layer is formed with at least one laminate unit of alternately laminated inorganic layer and organic layer, and it may be formed on at least one side of the support. The gas barrier layer may be formed on the both sides. As the gas barrier layer, one or more of the inorganic layer or organic layer (preferably 3 or more layers consisting of alternately laminated organic layer and inorganic layer) may be laminated adjacently to the aforementioned laminate unit, or one or more sets of the aforementioned laminate unit may be repeatedly stacked adjacently to the aforementioned laminate unit. When such repeating units are formed, the number of the units should be 5 or less, preferably 2 or less, in view of the gas barrier property, production efficiency and so forth. Further, when the repeating units are formed, two or more of the inorganic layers and organic layers may have the same compositions or different compositions, respectively.

<Functional Layer>

The film of the present invention can further have any of the following various functional layers in addition to the aforementioned gas barrier layer. Hereafter, the constituent functional layers will be explained one by one.

(Transparent Electrode Layer)

As a transparent conductive layer that can be formed in the film of the present invention, known metal films and metal oxide films can be used. Metal oxide films are particularly preferred in view of transparency, conductivity and mechanical characteristics. Examples include, for example, metal oxide films such as those of indium oxide, cadmium oxide and tin oxide added with tin, tellurium, cadmium, molybdenum, tungsten, fluorine or the like as impurities, zinc oxide, titanium oxide added with aluminum as impurities and so forth. In particular, thin films of indium oxide containing 2 to 15 weight % of tin oxide (ITO) have superior transparency and conductivity, and therefore they are preferably used. Examples of the method of forming the transparent conductive layer include the vacuum deposition method, sputtering method, ion beam sputtering method and so forth. A method of applying the aforementioned metal and/or metal oxide microparticles as a mixture with a binder may also be used. Further, a fluorine type surfactant, cationic surfactant or amphoteric surfactant may also be applied with a binder.

The film thickness of the transparent conductive layer is preferably in the range of 15 to 300 nm, if it is a vapor-deposited thin film. If the film thickness of the transparent conductive layer is smaller than 15 nm, the film may become a discontinuous film, and thus conductivity may become insufficient. On the other hand, if the film thickness exceeds 300 nm, transparency may be degraded, and flex resistance may also be degraded. For an applied type thin film, the thickness is preferably 50 to 1000 nm. If the film thickness of the transparent conductive layer is smaller than 50 nm, the film may highly possibly become a discontinuous film, and if the film thickness exceeds 1000 nm, flex resistance may be degraded.

The transparent conductive layer on the back face side may be provided at any position so long as it is provided on the back face side of the support. However, it is preferably provided as the uppermost layer on the back face side if static electricity removing ability is taken into consideration. On the other hand, the transparent conductive layer on the surface side of the support may be provided on the base material side or the gas barrier layer side so long as it is provided as an outermost layer. However, it is preferably provided on the gas barrier layer side in view of prevention of invasion of moisture contained in the support in a small amount.

(Primer Layer)

In the film of the present invention, a known primer layer or inorganic thin film layer can be provided between the support and the gas barrier layer. Although acrylic resins, epoxy resins, urethane resins, silicone resins and so forth, for example, can be used for the primer layer, it is preferable in the present invention to use an organic/inorganic hybrid layer as the primer layer and an inorganic vapor-deposited layer or dense inorganic coated thin film prepared by a sol/gel method as the inorganic thin film layer. As the inorganic vapor-deposited layer, vapor-deposited layers of silica, zirconia, alumina and so forth are preferred. The inorganic vapor-deposited layer can be formed by the vacuum deposition method, sputtering method or the like.

(Other Functional Layers)

On the gas barrier layer or as an outermost layer, various known functional layers may be provided as required. Examples of the functional layers include optically functional layers such as anti-reflection layer, polarization layer, color filter, ultraviolet absorbing layer and light extraction efficiency improving layer, mechanically functional layers such as hard coat layer and stress relaxation layer, electrically functional layers such as antistatic layer and conductive layer, antifogging layer, antifouling layer, printable layer and so forth.

The film of the present invention suitably has an oxygen permeability of 0 to 0.02 mL/m²·day·atm, preferably 0 to 0.01 mL/m²·day·atm, more preferably 0 to 0.005 mL/m²·day·atm, at 38° C. and 90% of relative humidity. If a film having an oxygen permeability of 0.02 mL/m²·day·atm or less at 38° C. and 90% of relative humidity is used in, for example, an organic EL device or LCD, degradation of the EL device by oxygen can be substantially avoided, and therefore such an oxygen permeability is preferred.

Further, the film of the present invention suitably has a water vapor permeability of 0 to 0.02 g/m²·day, preferably 0 to 0.01 g/m²·day, more preferably 0 to 0.005 g/m2·day, at 38° C. and 90% of relative humidity.

Oxygen permeability and water vapor permeability of the film of the present invention can be measured by, for example, the MOCON method (oxygen permeability: MOCON OX-TRAN 2/20L, water vapor permeability: MOCON PERMATRAN-W3/31).

[Method for Producing Gas Barrier Laminate Film]

The method for producing the film of the present invention is characterized in that, before, during or after lamination of the gas barrier layer on the support, the surface of the support on the side opposite to the surface laminated or to be laminated with the gas barrier layer is subjected to at least one kind of treatment selected from the group consisting of corona discharge treatment, electron beam irradiation and flame treatment to form unevenness represented by an Ra value of 1 to 20 nm on the treated surface.

As for electric discharge or irradiation energy, treatment time and so forth used in the corona discharge treatment, electron beam irradiation and flame treatment as the treatment method, conditions used in various treatments can suitably be chosen and used.

The time of forming a surface having unevenness represented by an Ra value of 1 to 20 nm on the film back face may any time before the gas barrier layer is laminated on the support, during the lamination of the gas barrier layer or after the lamination of the gas barrier layer. Unevenness is preferably formed before the lamination of the gas barrier layer.

In the production method of the present invention, unevenness represented by an Ra value of 1 to 20 nm on the film back face can also be formed by, before, during or after lamination of the gas barrier layer on the support, pressing the surface of the support on the side opposite to the surface laminated or to be laminated with the gas barrier layer on an embossing roller having an Ra value of 10 nm to 1 μm and an RSm value of 20 μm or less.

When the aforementioned unevenness is formed with an embossing roller, the embossing treatment is preferably conducted by putting the support between the embossing roller and a backup roller. The pressing with the embossing roller may be performed during the production of the support before laminating the gas barrier layer, or may be performed during the lamination of the gas barrier layer or after the lamination.

[Image Display Device]

Although the use of the film of the present invention is not particularly limited, it can be suitably used as a transparent electrode substrate of image display device because of the superior optical characteristics and mechanical characteristics thereof. The “image display device” referred to in the present specification means a circularly polarizing plate, liquid crystal display device, touch panel, organic EL device or the like.

Further, flat panel displays showing superior display quality can be produced by using the film of the present invention. Examples of display devices of flat panel displays or flat panel displays include liquid crystal panels, plasma displays, electroluminescence (EL) panels, fluorescent character display tubes, light emitting diodes and so forth, and other than these, the film can be used as a substrate replacing glass substrates of displays in which glass substrates have conventionally been used. Furthermore, in addition to displays, the film of the present invention can also be used for applications of optical components such as solar battery and touch panel. As for touch panel, the film of the present invention can be used for those disclosed in Japanese Patent Laid-open Publication Nos. 5-127822, 2002-48913 and so forth.

<Liquid Crystal Display Device>

A reflection type liquid crystal display device has a structure consisting of, in the order from the bottom, a lower substrate, reflective electrode, lower oriented film, liquid crystal layer, upper oriented film, transparent electrode, upper substrate, λ/4 plate and polarizing film. Among these, the film of the present invention can be used as the aforementioned λ/4 plate or a protective film for the polarizing film by adjusting the optical characteristics. However, it is preferably used as the substrate in view of the heat resistance, and it is also preferably used as the transparent electrode and upper substrate having an oriented film in view of the transparency. Further, a gas barrier layer, TFT etc. may be provided as required. In the case of a color display device, it is preferable to further provide a color filter layer between the reflective electrode and the lower oriented film or between the upper oriented film and the transparent electrode.

A transmission type liquid crystal display device has a structure consisting of, in the order from the bottom, a back light, polarizing plate, λ/4 plate, lower transparent electrode, lower oriented film, liquid crystal layer, upper oriented film, upper transparent electrode, upper substrate, λ/4 plate and polarization film. Among these, the film of the present invention can be used as the λ/4 plate or a protective film for the polarizing film by adjusting the optical characteristics. However, it is preferably used as the substrate in view of the heat resistance, and it is also preferably used as the transparent electrode and substrate having an oriented film in view of the transparency. Further, a gas barrier layer, TFT etc. may be provided as required. In the case of a color display device, it is preferable to further provide a color filter layer between the lower transparent electrode and the lower oriented film or between the upper oriented film and the transparent electrode.

Type of liquid crystal cell is not particularly limited, and various display modes such as TN (Twisted Nematic), IPS (In-Plane Switching), FLC (Ferroelectric Liquid Crystal), AFLC (Anti-ferroelectric Liquid Crystal), OCB (Optically Compensatory Bend), STN (Supper Twisted Nematic), VA (Vertically Aligned) and HAN (Hybrid Aligned Nematic) have been proposed. Furthermore, display modes in which alignment division (multi-domain) is adopted with the aforementioned display modes have also been proposed. The film of the present invention is effective in liquid crystal display devices of any display mode. Furthermore, it is also effective in any of liquid crystal displays of transmission type, reflection type and semi-transmission type.

These display modes are disclosed in Japanese Patent Laid-open Publication No. 2-176625, Japanese Patent Publication No. 7-69536, MVA in SID97, Digest of tech. Papers, 28 (1997) 845, SID99, Digest of tech. Papers 30, (1999) 206, Japanese Patent Laid-open Publication No. 11-258605, SURVAIVAL in Monthly Display, Vol. 6, No. 3 (1999) 14, PVA in Asia Display 98, Proc. of the-18th-Inter. Display res. Conf. (1998) 383, Para-A in LCD/PDP Iternational '99, DDVA in SID98, Digest of tech. Papers 29 (1998) 838, EOC in SID98, Digest of tech. Papers, 29 (1998) 319, PSHA in SID98, Digest of tech. Papers, 29 (1998) 1081, RFFMH in Asia Display 98, Proc. of the-18th-Inter. Display res. Conf. (1998) 375, HMD in SID98, Digest of tech. Papers, 29 (1998) 702, Japanese Patent Laid-open Publication No. 10-123478, International Patent Publication W098/48320, Japanese Patent No. 3022477, International Patent Publication WO00/65384 and so forth.

<Touch Panel>

As for touch panel, the film of the present invention can be applied to those described in Japanese Patent Laid-open Publication Nos. 5-127822, 2002-48913 and so forth.

<Organic EL Device>

The film of the present invention can be used for organic EL displays as a substrate having a transparent electrode, after providing TFT if necessary. Specific examples of layer structure of organic EL display device include positive electrode/luminescent layer/transparent negative electrode, positive electrode/luminescent layer/electron transport layer/transparent negative electrode, positive electrode/hole transport layer/luminescent layer/electron transport layer/transparent negative electrode, positive electrode/hole transport layer/luminescent layer/transparent negative electrode, positive electrode/luminescent layer/electron transport layer/electron injection layer/transparent negative electrode, positive electrode/hole injection layer/hole transport layer/luminescent layer/electron transport layer/electron injection layer/transparent negative electrode and so forth.

With an organic EL device for which the film of the present invention can be used, light emission can be obtained by applying a direct current (alternating current component may be included as required) voltage (usually 2 to 40 V) or direct current between the positive electrode and the negative electrode. For driving of such light emitting elements, the methods described in Japanese Patent Laid-open Publication Nos. 2-148687, 6-301355, 5-29080, 7-134558, 8-234685, 8-241047, U.S. Pat. Nos. 5,828,429, 6,023,308, Japanese Patent No. 2784615 and so forth can be used.

### EXAMPLES

Hereafter, the gas barrier laminate film of the present invention will be further specifically explained by referring to examples. However, the present invention is not a limited to these.

Methods used for the measurement of the characteristic values in the examples are shown below.

Measurement of Arithmetic Average Roughness (Ra Value)

Arithmetic average roughness (Ra) of surface was measured by using “Micromap” produced by RYOKA SYSTEM Inc.

Evaluation of Rolled Shape of Film

Smoothness of end-surface of a roll obtained by rolling up a film was evaluated. As for the evaluation method, the maximum displacement length of the film with respect to a portion at which the rolling up was started, and evaluation was made on the basis of the absolute value of the displacement length.

Evaluation of Gas Barrier Property

A sample was obtained from a substantially central portion for the transverse direction of the film near the core, and water vapor permeability of the film sample was measured by the MOCON method (MOCON PERMATRAN-W3/31) in an environment of 38° C. and 90% RH.

Evaluation of Scratches on Film Surface

A sample was obtained from a substantially central portion for both of the longitudinal and transverse directions of the film, and presence or absence of the scratches was evaluated by visual inspection under illumination of a point light source and classified into five levels. The results were evaluated with the five levels of from “no scratch (0)” to “many scratches (4)”.

Measurement of Transparency (Parallel Light Transmission)

Transmission of parallel light was measured in a conventional manner by using a commercially available haze meter.

### Example 1

1. Preparation and Application of Application Solution of Matting Agent

Polyimide varnish, matting agent and N-methylpyrrolidone were mixed in the amounts shown in Table 1 (the numerals in Table 1 represent parts by weight) with dissolving the resin to prepare application solutions in which the matting agent is dispersed. Each of the obtained application solutions was coated on a polyimide film (UPILEX 50S produced by Ube Industries, Ltd.), of which back face was subjected to corona discharge treatment beforehand, by using a wire bar in a coating amount of 15 mL/m², 30 mL/m² or 60 mL/m², and dried at 100° C. for 30 minutes, then at 200° C. for 30 minutes and further then at 300° C. for 60 minutes to attain condensation.

TABLE 1

| | Application solution | | | | | |
|---|---|---|---|---|---|---|
| | 1 | 2 | 3 | 4 | 5 | 6 |
| N-Methylpyrrolidone | 20 | 20 | 20 | 20 | 20 | 20 |
| U-Varnish-A | 0.08 | 0.08 | 0.08 | 0.08 | 0.08 | 0.08 |
| (binder) | | | | | | |
| (20 weight %) | | | | | | |
| Type of matting | Silica | | | Benzoguanamine | | |
| agent | | | | formaldehyde | | |
| | | | | condensate | | |
| Particle size of | 0.1 | 0.5 | 1.0 | 0.1-0.3 | 0.25-0.55 | 1-2 |
| matting agent (μm) | | | | | | |
| Shape of matting | Sphere | Sphere | Sphere | Sphere | Sphere | Sphere |
| agent | | | | | | |
| Trade name of | SEAHOSTAR (NIPPON | | | EPOSTAR (NIPPON | | |
| matting agent | SHOKUBAI) | | | SHOKUBAI) | | |
| Product number | KE-P10 | KE-P50 | KE-P100 | S | S6 | S12 |
| Amount of matting | 0.15 | 0.15 | 0.017 | 0.15 | 0.15 | 0.017 |
| agent (solid | | | | | | |
| matter) | | | | | | |

2. Formation of Gas Barrier Layer Containing Applied Type Organic Barrier Layer (A)

Soarnol D2908 (ethylene/vinyl alcohol copolymer produced by Nippon Synthetic Chemical Industry Co., Ltd.) in an amount of 8 g was dissolved in a mixed solvent of 118.8 g of 1-propanol and 73.2 g of water at 80° C. 2 mol/L hydrochloric acid in a volume of 2.4 mL was added to 10.72 g of this solution and mixed. Tetraethoxysilane in an amount of 1 g was added dropwise to the solution with stirring, and stirring was continued for 30 minutes. Then, dimethylbenzylamine was added to the solution as a pH adjuster immediately before the application of the obtained application solution, and the solution was applied to the support surface subjected to corona discharge treatment (the surface opposite to the surface on which the matting agent was applied) by using a wire bar. Then, a microwave was irradiated on the whole surface, and the applied layer was dried at 120° C. to form an applied type organic barrier layer having a film thickness of 1 μm on the support surface.

On this film, deposition was performed by a reaction under vacuum while controlling the amounts of silicon vapor and introduced oxygen gas to form a silicon oxide layer (inorganic barrier layer) having a thickness of 60 nm.

The above procedures were repeated 3 times to prepare a gas barrier laminate film having a gas barrier layer of a six-layer structure.

3. Formation of Gas Barrier Layer Containing Organic Barrier Layer Prepared by Flash Vapor-deposition Method (B)

A mixture of 50 mL of tetraethylene glycol diacrylate, 14.5 mL of tripropylene glycol monoacrylate, 7.25 mL of caprolactone acrylate, 10.15 mL of acrylic acid and 10.15 mL of EZACURE (photopolymerization initiator consisting of benzophenone mixture produced by Sartomer) was mixed with 36.25 g of particles of solid N,N′-bis(3-methylphenyl)-N,N′-diphenylbenzidine having polydispersed particle size distribution. Then, the mixture was stirred by using an ultrasonic wave tissue mincer at 20 kHz for about 1 hour to pulverize the solid particles and thereby prepare fine suspension. The mixture was diluted to a concentration of about 20 volume % (namely, 36.25 g), heated to about 45° C. and stirred. The mixture was fed into a 1.30 mm spray nozzle through a capillary tube having an inner diameter of 2.0 mm and a length of 610 mm by using a pump, and the mixture was sprayed from the nozzle as minute drops by using a 25 kHz ultrasonic sprayer and dropped onto the surface maintained at about 340° C. The flash evaporation chamber wall was maintained at about 290° C. to prevent cryocondensation of the monomers on the flash evaporation chamber wall. The vapor was cryocondensed on the film surface (the surface on the side opposite to the surface on which the matting agent was applied) cooled with cooling water of about 13° C. and then cured with a UV ray to form a polymer layer having a thickness of 4 μm. As the apparatus for performing the flash evaporation, the apparatus described in International Patent Application Unexamined Publication in Japanese (Kohyo) No. 2001-518530 was manufactured and used for the experiment.

On the above organic barrier layer, deposition was performed by a reaction under vacuum while controlling the amounts of aluminum vapor and introduced oxygen gas to form an aluminum oxide layer (inorganic barrier layer) having a thickness of 60 nm.

The above procedures were repeated 3 times to prepare a gas barrier laminate film having a gas barrier layer of a six-layer structure.

The aforementioned film in a length of 2000 m was rolled up under the conditions of a linear velocity of 50 m/min and tension of 10 kg/m, and arithmetic average roughness (Ra value), rolled shape, water vapor permeability for a portion near the core for rolling up, scratches for a portion near the center for the longitudinal direction and transparency (parallel light transmission) of the film after the rolling up were evaluated. The results are shown in Table 2.

### Comparative Example 1

Gas barrier laminate films were produced in the same manner as in Example 1 except that the matting agent was not added in the application solutions mentioned in Table 1.

TABLE 2

| | | | | Inorganic | | | | Parallel | |
|---|---|---|---|---|---|---|---|---|---|
| Applied sample | | | | barrier layer | | | | light | |
| (Application | | | | A: Applied type | Rolled | Water vapor | | trans- | |
| solution/ | | | Ra | B: Vapor- | shape | permeability | | mission | |
| applied amount) | | Film | [nm] | deposited type | [cm] | [g/m² · day] | Scratch | [%] | Note |
| 1 | 15 ml/m² | 1a | 3.5 | A | 0.8 | <0.005 | 0 | 89 | Inv. |
| 1 | 30 ml/m² | 1b | 4.2 | A | 0.7 | <0.005 | 0 | 87 | Inv. |
| 1 | 60 ml/m² | 1c | 4.6 | A | 1.1 | <0.005 | 1 | 85 | Inv. |
| 1 | 15 ml/m² | 1d | 3.8 | B | 1.5 | <0.005 | 1 | 90 | Inv. |
| 1 | 30 ml/m² | 1e | 4.1 | B | 0.9 | <0.005 | 0 | 88 | Inv. |
| 1 | 60 ml/m² | 1f | 4.6 | B | 0.9 | <0.005 | 0 | 87 | Inv. |
| 2 | 15 ml/m² | 2a | 3.8 | A | 1.2 | <0.005 | 1 | 92 | Inv. |
| 2 | 30 ml/m² | 2b | 4.4 | A | 0.6 | <0.005 | 0 | 90 | Inv. |
| 2 | 60 ml/m² | 2c | 4.8 | A | 0.3 | <0.005 | 0 | 88 | Inv. |
| 2 | 15 ml/m² | 2d | 3.6 | B | 1.1 | <0.005 | 0 | 92 | Inv. |
| 2 | 30 ml/m² | 2e | 3.9 | B | 1.3 | <0.005 | 1 | 90 | Inv. |
| 2 | 60 ml/m² | 2f | 4.3 | B | 0.7 | <0.005 | 0 | 87 | Inv. |
| 3 | 30 ml/m² | 3a | 4.5 | A | 0.9 | <0.005 | 2 | 91 | Inv. |
| 3 | 30 ml/m² | 3b | 4.8 | B | 0.6 | <0.005 | 1 | 92 | Inv. |
| 4 | 30 ml/m² | 4a | 3.9 | A | 0.8 | <0.005 | 0 | 89 | Inv. |
| 4 | 30 ml/m² | 4b | 4.1 | B | 1.1 | <0.005 | 0 | 89 | Inv. |
| 5 | 30 ml/m² | 5a | 3.5 | A | 1.5 | <0.005 | 0 | 90 | Inv. |
| 5 | 30 ml/m² | 5b | 3.4 | B | 0.8 | <0.005 | 0 | 88 | Inv. |
| 6 | 30 ml/m² | 6a | 4.9 | A | 0.9 | <0.005 | 2 | 90 | Inv. |
| 6 | 30 ml/m² | 6b | 5.2 | B | 0.7 | <0.005 | 1 | 89 | Inv. |
| — | — | 7a | 0.5 | A | 20 | 10.5 | 3 | 92 | Comp. |
| — | — | 7b | 0.3 | B | 25 | 8.7 | 4 | 93 | Comp. |

As seen from the results shown in Table 2, all the films of the present invention showed a displacement less than 2 cm in the rolled shape after rolling up, water vapor permeability less than 0.005 g/m²·day and scratches in the range of evaluation scores of 0 to 2. On the other hand, the films of comparative examples showed a displacement of 20 cm or more in the rolled shape after rolling up, water vapor permeability exceeding 8 g/m2·day and scratches in the range of evaluation score of 3 or higher.

From these results, it can be seen that by using the film of the present invention, the adhesion and delamination of the support back face and the gas barrier layer after rolling up can be effectively prevented, thus the gas barrier layer is not damaged, and superior gas barrier performance can be obtained.

### Example 2

1. Preparation of Organic EL Device

Film 1a was introduced into a vacuum chamber, and a transparent electrode composed of an IXO thin film having a thickness of 0.2 μm was formed by DC magnetron sputtering using an IXO target. An aluminum lead wire was connected to the transparent electrode (IXO) to form a laminated structure. An aqueous dispersion of polyethylene dioxythiophene/polystyrenesulfonic acid (Baytron P, BAYER, solid content: 1.3 weight %) was applied on the surface of the transparent electrode by spin coating and then vacuum-dried at 150° C. for 2 hours to form a hole transporting organic thin film layer having a thickness of 100 nm. This was designated Substrate X.

Further, an application solution for light-emitting organic thin film layer having the following composition was applied on one side of a temporary support made of polyethersulfone having a thickness of 188 μm (SUMILITE FS-1300 produced by Sumitomo Bakelite) by using a spin coater and dried at room temperature to form a light-emitting organic thin film layer having a thickness of 13 nm on the temporary support. This was designated Transfer Material Y.

| | | |
|---|---|---|
| Polyvinyl carbazole | 40 | parts by weight |
| (Mw = 63000, Aldrich) | | |
| Tris(2-phenylpyridine) iridium | 1 | part by weight |
| complex (Ortho-metalated complex) | | |
| Dichloroethane | 3200 | parts by weight |

The light-emitting organic thin film layer side of Transfer Material Y was overlaid on the upper surface of the organic thin film layer of Substrate X, heated and pressurized under the conditions of 160° C., 0.3 MPa and 0.05 m/min by using a pair of heat rollers, and the temporary support was delaminated to form a light-emitting organic thin film layer on the upper surface of Substrate X. This was designated Substrate XY.

Further, a patterned mask for vapor deposition (mask providing a light-emitting area of 5 mm×5 mm) was set on one side of a polyimide film (UPILEX-50S, Ube Industries) cut into a 25-mm square and having a thickness of 50 μm, and Al was vapor-deposited in a reduced pressure atmosphere of about 0.1 mPa to form an electrode having a film thickness of 0.3 μm. Al₂O₃ was vapor-deposited by DC magnetron sputtering using an Al₂O₃ target with a film thickness of 3 nm in the same pattern as the Al layer. An aluminum lead wire was connected to the Al electrode to form a laminated structure. An application solution for electron transporting organic thin film layer having the following composition was applied on the obtained laminated structure by using a spin coater and vacuum-dried at 80° C. for 2 hours to form an electron transporting organic thin film layer having a thickness of 15 nm on Al₂O₃. This was designated Substrate Z.

| | | |
|---|---|---|
| Polyvinyl butyral | 10 | parts by weight |
| (2000L produced by Denki | | |
| Kagaku Kogyo, Mw = 2000,) | | |
| 1-Butanol | 3500 | parts by weight |
| Electron transporting compound | 20 | parts by weight |
| having the following structure | | |

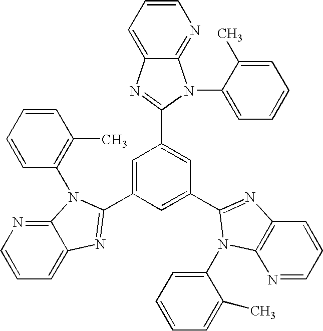

Substrate XY and Substrate Z were stacked so that the electrodes should face each other via the light-emitting organic thin film layer between them, heated and pressurized at 160° C., 0.3 MPa and 0.05 m/min by using a pair of heat rollers to obtain Organic EL Device 1.

Further, as a comparative organic EL device, Organic EL Device 2 was prepared by using Film 7a as the support in the preparation of Substrate X.

DC voltage was applied to the obtained Organic EL Devices 1 and 2 by using Source-Measure Unit Model 2400 (Toyo Corporation) to allow them to emit light. Both of Organic EL Devices 1 and 2 showed good light emission.

After the production of Organic EL Devices 1 and 2, they were left in an environment of 25° C. and 75% RH for 1 month. Then, they were allowed to emit light in the same manner. As a result, Organic EL Device 1 showed good light emission, whereas defects increased in Organic EL Device 2.

From the above results, it can be seen that if the film of the present invention is used in an organic EL device, superior gas barrier property can be maintained even after long term storage under a high humidity condition.

The film of the present invention can effectively prevent the adhesion and delamination of the support back face and the gas barrier layer during rolling up or transportation, and thus a gas barrier layer having few scratches can be obtained. Therefore, the film of the present invention can be used for various image display devices such as those for flat panel displays as a gas barrier laminate film showing little degradation of gas barrier performance and conduction performance.

The present disclosure relates to the subject matter contained in Japanese Patent Application No. 067077/2004 filed on Mar. 10, 2004, which is expressly incorporated herein by reference in its entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

1. A gas barrier laminate film comprising a gas barrier layer laminated on at least one surface of a support, wherein a surface of the support on the side opposite to the surface laminated with the gas barrier layer has unevenness represented by an Ra value of 1 to 20 nm.

2. The gas barrier laminate film according to claim 1, wherein the Ra value is within the range of 2 to 8 nm.

3. The gas barrier laminate film according to claim 1, wherein the gas barrier layer consists of at least three layers of alternately laminated organic layer and inorganic layer.

4. The gas barrier laminate film according to claim 1, which has 50 to 150 mg/m² of a matting agent having an average particle size less than 1 μm as an equivalent spherical diameter on the surface of the support on the side opposite to the surface laminated with the gas barrier layer.

5. The gas barrier laminate film according to claim 4, wherein the matting agents have a microhardness of 100 to 250 N/mm².

6. The gas barrier laminate film according to claim 1, which has 10 to 25 mg/m² of a matting agent having an average particle size of 1 to 3 μm as an equivalent spherical diameter on the surface of the support on the side opposite to the surface laminated with the gas barrier layer.

7. The gas barrier laminate film according to claim 6, wherein the matting agents have a microhardness of 100 to 250 N/mm².

8. The gas barrier laminate film according to claim 1, wherein the surface of the support on the side opposite to the surface laminated with the gas barrier layer is a surface having unevenness formed by at least one kind of treatment selected from the group consisting of corona discharge treatment, electron beam irradiation and flame treatment.

9. The gas barrier laminate film according to claim 1, wherein the surface of the support on the side opposite to the surface laminated with the gas barrier layer is a surface having unevenness formed by pressing an embossing roller having an Ra value of 10 nm to 1 μm and an RSm value of 20 μm or less.

10. The gas barrier laminate film according to claim 1, wherein the surface of the support on the side opposite to the surface laminated with the gas barrier layer has a surface resistance of 1 to 1×10¹⁰ Ω/□ in an environment of 25° C. and 50% RH.

11. The gas barrier laminate film according to claim 1, wherein the support is a heat resistant support comprising a polymer having a glass transition temperature of 200° C. or higher.

12. The gas barrier laminate film according to claim 1, wherein the support is a film comprising a polymer having a spiro structure represented by the following formula (1): 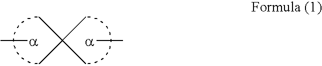
wherein, in the formula (1), the rings α represent a monocyclic or polycyclic ring, and two of the rings are bound via a spiro bond.

13. The gas barrier laminate film according to claim 1, wherein the support is a film comprising a polymer having a cardo structure represented by the following formula (2): 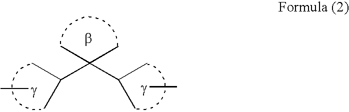
wherein, in the formula (2), the ring β and the rings γ independently represent a monocyclic or polycyclic ring, and two of the rings γ may be identical or different and are bonded to one quaternary carbon atom in the ring β.

14. An image display device utilizing the gas barrier laminate film according to claim 1.

15. The image display device according to claim 14, wherein the image display device is an organic EL device.

16. A method for producing a gas barrier laminate film comprising a gas barrier layer laminated on at least one surface of a heat resistant support, wherein before, during or after lamination of the gas barrier layer on the support, the surface of the support on the side opposite to the surface laminated with the gas barrier layer is subjected to at least one kind of treatment selected from the group consisting of chemical etching, physical etching, embossing and coating of matting agents to form unevenness represented by an Ra value of 1 to 20 nm on the treated surface.

17. The method for producing a gas barrier laminate film according to claim 16, wherein the treatment is conducted before the lamination of the gas barrier layer on the support.

18. The method for producing a gas barrier laminate film according to claim 16, wherein the treatment is at least one kind selected from the group consisting of corona discharge treatment, electron beam irradiation and flame treatment.

19. The method for producing a gas barrier laminate film according to claim 16, wherein the treatment is corona discharge treatment.

20. The method for producing a gas barrier laminate film according to claim 16, wherein the treatment is pressing with an embossing roller having an Ra value of 10 nm to 1 μm and an RSm value of 20 μm or less.
